(19) United States
(12) Patent Application Publication
(10) Pub. No.: US 2014/0218178 A1
(43) Pub. Date: Aug. 7, 2014

(54) ONBOARD SYSTEM FOR SUPERVISING A MACHINE FROM A PORTABLE TERMINAL

(71) Applicant: Tewfik Meftah, Grenoble (FR)

(72) Inventor: Tewfik Meftah, Grenoble (FR)

(73) Assignee: Schneider Electric Industries SAS, Rueil Malmaison (FR)

(21) Appl. No.: 14/240,950

(22) PCT Filed: Aug. 9, 2012
(86) PCT No.: PCT/EP2012/065590

§ 371 Date: Feb. 25, 2014

(30) Foreign Application Priority Data
Sep. 1, 2011 (FR) 11 57756

(51) Int. Cl. G06K 7/10

(52) U.S. Cl. CPC G06K 7/10386; G06K 2007/10524
USPC 340/10.6

(57) ABSTRACT

A system for onboard supervision, from a portable terminal, of a machine connected to a supervision station, the portable terminal including a mechanism of wireless reading and onboard software, the supervision station including a man/machine interface exhibiting a set of selectable parameters. The system includes a mechanism for selecting a subset of parameters from among the set of selectable parameters and a mechanism for generating a code readable by the portable terminal by wireless mechanism reading, the code including a description of the subset of selected parameters. Moreover, the onboard software of the portable terminal generates an onboard man/machine interface displayed on the screen of the portable terminal, the onboard man/machine interface being dependent on the subset of selected parameters.

### TECHNICAL FIELD OF THE INVENTION

The present invention pertains to an onboard system allowing the supervision of a machine from a portable terminal. More precisely, the objective of the present invention is to provide a system allowing an operator to be afforded onboard supervision information during interventions on machines or parts of machines not locally exhibiting supervision man-machine interfaces.

### PRIOR ART

According to the prior art, when an operator is required to intervene on a machine that does not have its own man-machine interface or is too long or large and does not have sufficient man-machine interfaces, while the viewing of certain parameters is necessary, he generally has no other choice than to go back and forth between the machine and a remote or central supervision station to access the current values of these parameters or to modify them.

Moreover, the prior art discloses equipment comprising an integrated Web server able to communicate to the outside a set of parameters, on which the operator cannot intervene. To retrieve the values of these parameters, the operator must be able to connect to said Web server according to previously known communication parameters. Moreover, it is possible that the operator might need to access parameters distributed between several Web servers.

Moreover, the documents US 2006/0087402 A1 and US 2006/0205389 A1 describe systems allowing the monitoring notably the monitoring of subsets of systems of automatic controllers, involving portable terminals. However, no known solution allows an operator to have an onboard man-machine interface configured as a function of the parameters that he needs to supervise during an intervention on a machine.

The aim of the invention is therefore to propose an onboard supervision system comprising means for selecting, on a supervision station, a set of parameters to be supervised, said supervision station comprising means for generating a code readable by a portable terminal available to the operator, said portable terminal comprising software generating, on the basis of the code, a man-machine interface dependent on the set of selected parameters, allowing the supervision and optionally the modification, from the portable terminal, of said selected parameters.

### DISCLOSURE OF THE INVENTION

The invention thus consists of an onboard supervision system for the supervision, from a portable terminal, of a machine connected to a supervision station, said portable terminal comprising wireless reading means and onboard software, said supervision station comprising a man-machine interface presenting a set of selectable parameters. The system according to the invention is characterized by the fact that it comprises means of selection by an operator of a subset of parameters from among the set of selectable parameters and means for generating a code, readable by the portable terminal by way of its wireless reading means, said code containing a description of said subset of selected parameters, and by the fact that the onboard software of the portable terminal generates an onboard man-machine interface displayed on the screen of the portable terminal, said onboard man-machine interface being dependent on the subset of selected parameters.

Advantageously, the portable terminal and, respectively, the machine comprise an external communication interface allowing them to communicate with one another.

Advantageously, the code moreover comprises the definition of a mode of communication and of a communication protocol as well as an identifier of said machine.

Advantageously, the code can be a two-dimensional barcode and the wireless reading means then comprise a photographic apparatus and means for decoding said two-dimensional barcode.

Advantageously, the code can be a digital code stored in the memory of an RFID chip and the wireless reading means then essentially comprise an RFID reader.

Advantageously, the code can be a digital code stored in the memory of a USB dongle able to communicate by Wifi and the wireless reading means then comprise a Wifi communication module.

Advantageously, the code can be a digital code stored in the memory of a USB dongle able to communicate by Bluetooth and the wireless reading means then comprise a Bluetooth communication module.

Advantageously, the value of the parameters of the subset of selected parameters presented on the onboard man-machine interface displayed on the screen of the portable terminal is updated dynamically by way of the interpretation by suitable means of update information communicated by the machine to the portable terminal.

Advantageously, the mode of communication between the machine and the portable terminal can be Wifi, Bluetooth, or Zigbee.

### BRIEF DESCRIPTION OF THE FIGURES

Other characteristics and advantages will become apparent in the detailed description which follows offered with regard to the appended drawings which represent:

FIG. 1: a simple diagram of an exemplary platform supervised by an operator;

FIG. 2: a man-machine interface of a supervision station displaying a set of parameters;

FIG. 3: the previous man-machine interface, on which the operator has selected a subset of parameters;

FIG. 4: the screen of the previous supervision station, on which a two-dimensional barcode has been generated;

FIG. 5: the reading of the previous two-dimensional barcode with the aid of a portable terminal manipulated by the operator;

FIG. 6: a man-machine interface generated on the portable terminal as a function of the subset of selected parameters;

FIG. 7: the intervention of the operator on a machine remote from the supervision station;

FIG. 8: an exemplary alternative to the two-dimensional barcode, in the form of an NFC chip;

FIG. 9: another exemplary alternative to the two-dimensional barcode, in the form of a USB dongle.

### DETAILED DESCRIPTION OF THE INVENTION

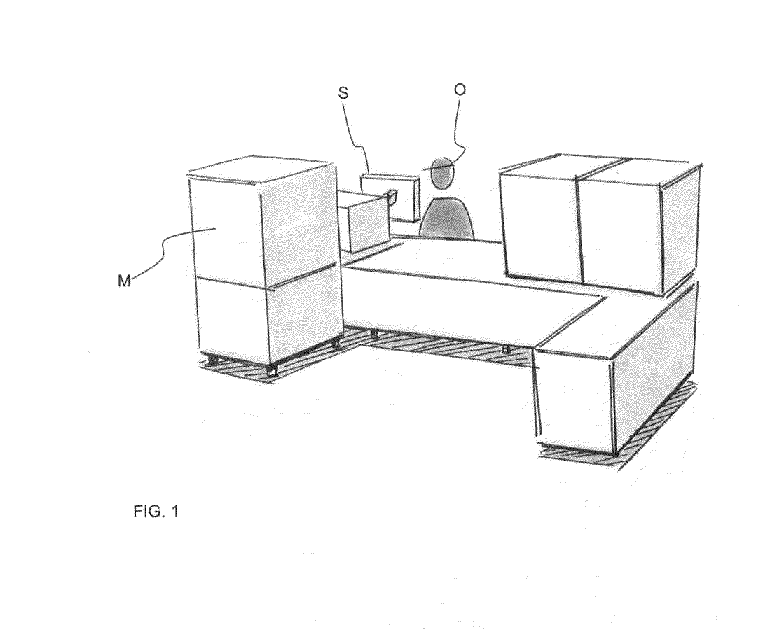

FIG. 1 represents an industrial platform supervised by an operator O with the aid of the supervision station S. The invention is aimed at facilitating an intervention on a machine remote from the supervision station, for example the machine M.

A supervision station S exhibits a man-machine interface allowing the operator O to ascertain and optionally to modify the value of parameters and variables related to the equipment that he is supervising. If, for example because of an anomaly, the operator O has to intervene on a machine M remote from the supervision station S, difficulties can arise. It is understood that “machine M remote from the supervision station S” is understood to mean that, from the location of the machine M, the operator O cannot see the screen of the supervision station S and/or interact with the man-machine interface 1 of the supervision station S. However, it may indeed be indispensable, in order to accomplish his intervention, for the operator O to ascertain the value of parameters involved in the anomaly or that have an influence on the behavior of the machine M for example. The present invention proposes means so that the operator O can have, on a portable terminal T, a man-machine interface specially configured to display the value of the parameters that the operator O needs.

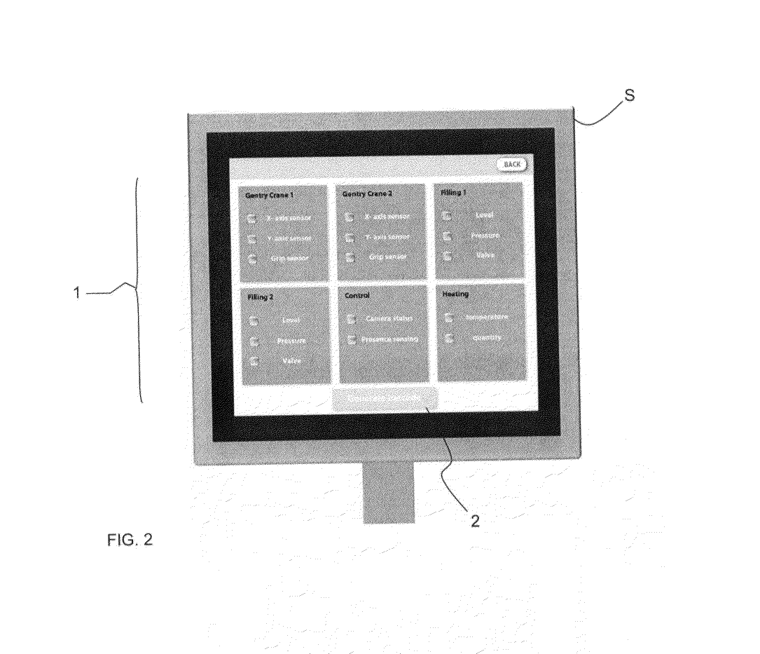

As represented in FIG. 2, the supervision station S thus comprises software making it possible to display on a screen of said supervision station S a man-machine interface 1 presenting a set of selectable parameters, the selection being able for example to be made by ticking the corresponding box or boxes.

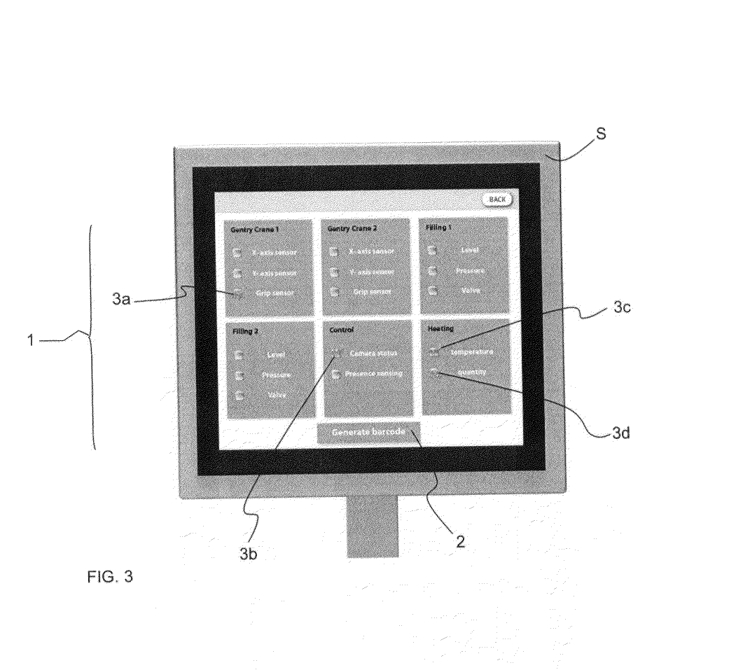

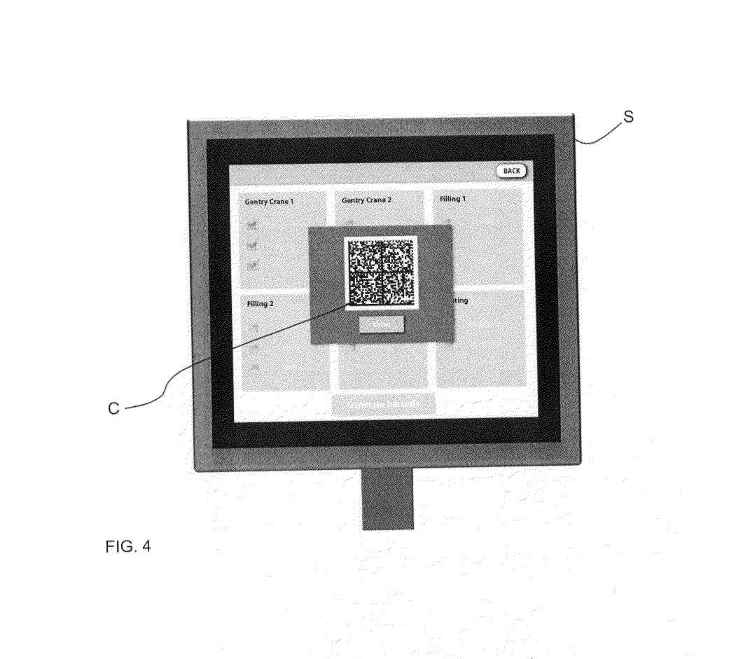

When he has selected the parameters 3a, 3b, 3c, 3d that he will need for his intervention, the operator O, as represented in FIG. 3, instigates, for example via a click on a “Generate code” button, the generation of a code by the software of the supervision station S. Such a code is represented in the form of a two-dimensional barcode C in FIG. 4; it is displayed on a screen of the supervision station S. This code comprises the definition of the parameters of the subset of selected parameters 3a, 3b, 3c, 3d. The definition of each parameter can for example comprise its name, whether it belongs to a part of the machine M or to a group of parameters, its address, its type, its mode of access—read/write or read only—, its minimum and maximum values, etc. It can advantageously moreover comprise communication parameters with a view to allowing communication between the portable terminal T and the machine M. These communication parameters can comprise the compatible mode or modes of communication, for example Wifi or Bluetooth, the communication protocol to be used, as well optionally as the identifier or the network address of the machine M. By way of example, if the communication is done using Bluetooth, the communication parameters may be: the name of the machine M, its MAC address, its pairing code. The communication protocol used may be: modbus RTU, Canopen, or any other protocol supported at one and the same time by the machine M, the communication means and the portable terminal T.

For possible security reasons, the code C may be encrypted and will be deciphered only by appropriate software means.

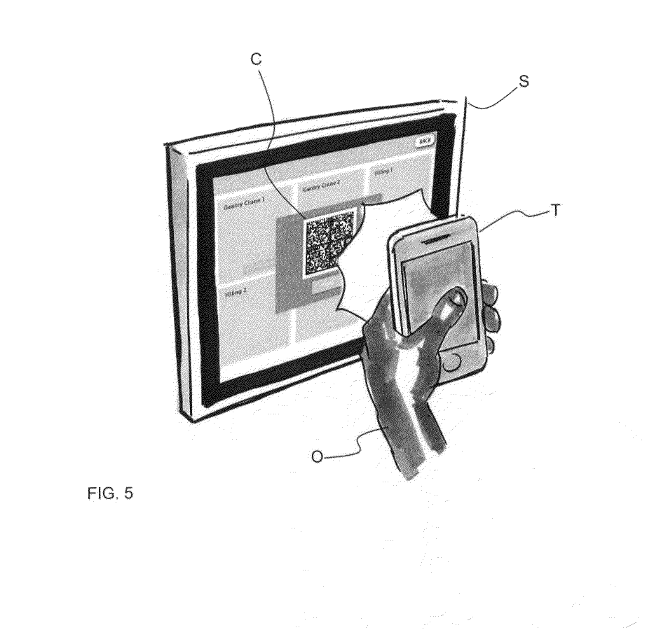

According to the invention, the operator has a portable terminal T comprising wireless means for reading the code displayed on the screen of the supervision station S. In the first embodiment considered, the code is a two-dimensional barcode C. In accordance with the diagram of FIG. 5, the portable terminal T then comprises a photographic apparatus allowing the operator O to photograph the two-dimensional barcode C.

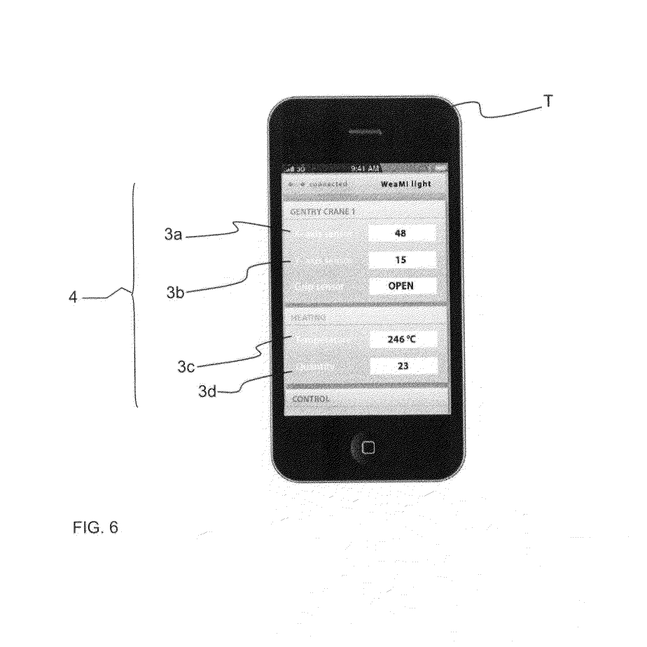

As represented in FIG. 6, in the system according to the invention, the portable terminal T comprises software means for decoding the code C read on the man-machine interface 1 of the supervision station S, as well as means for generating an onboard man-machine interface 4 on the portable terminal T, said onboard man-machine interface 4 being dependent on the information contained in the code C. In particular, the onboard man-machine interface 4 displays the parameters selected 3a, 3b, 3c, 3d by the operator 0. Preferably by way of a direct communication established with the aid of the communication parameters advantageously contained in the code C, the value of the parameters selected 3a, 3b, 3c, 3d is updated dynamically on the onboard man-machine interface 4. Alternatively, this updating can be performed via a communication between the portable terminal T and the supervision station S to which the machine M is connected.

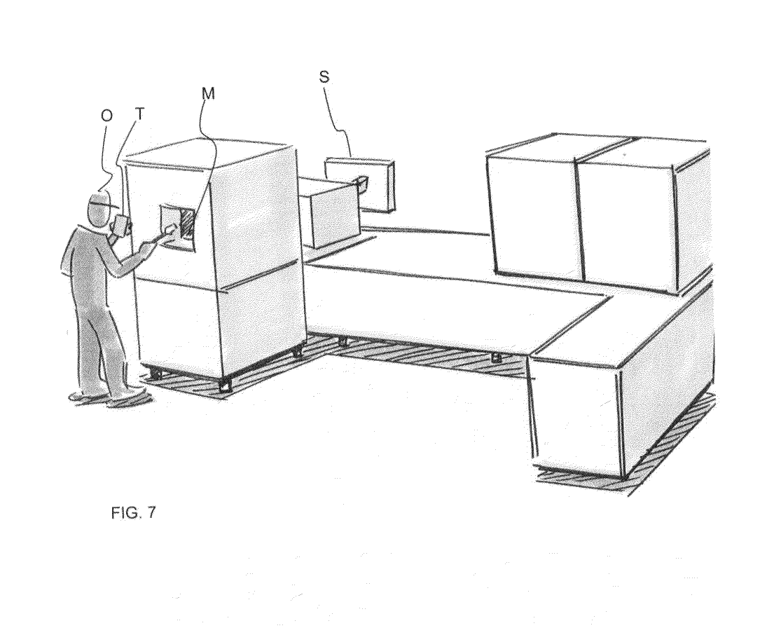

To summarize, as is shown diagrammatically in FIG. 7, the operator O can, by virtue of the present invention, intervene on the machine M from where he cannot see the supervision station S, while having at his disposal the values of the parameters of interest to him on his portable terminal T.

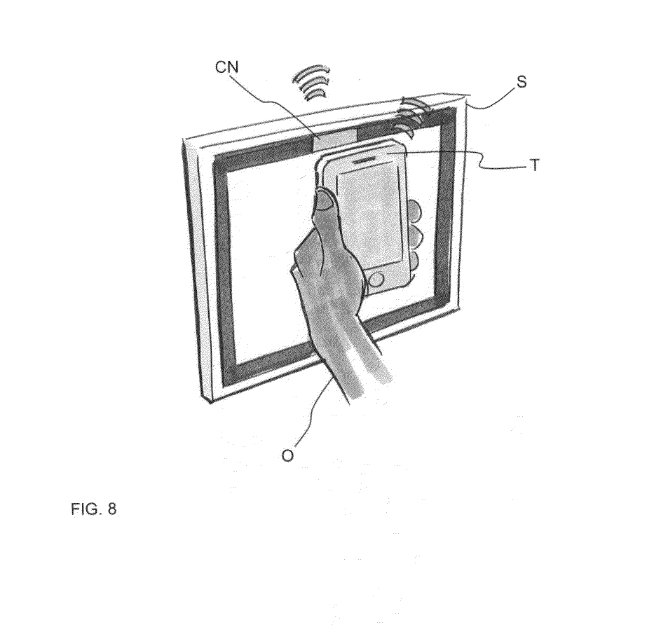

The system according to the invention can be implemented in an equivalent manner without recourse to the generation of a two-dimensional barcode C. A first alternative consists of means for generating a digital code stored by the software of the supervision station S in the memory of an NFC (Near Field Communication) chip, as represented in FIG. 8, the NFC chip being labeled CN. The portable terminal T is then fitted with NFC communication means for reading the memory of the NFC chip.

It is also possible to proceed in the same manner as for NFC technology, but by relying on the more general RFID technology. In this case, the software of the supervision station S comprises means for generating a digital code stored in the memory of an RFID chip and the portable terminal T is fitted with an RFID reader suitable for reading the memory of said RFID chip.

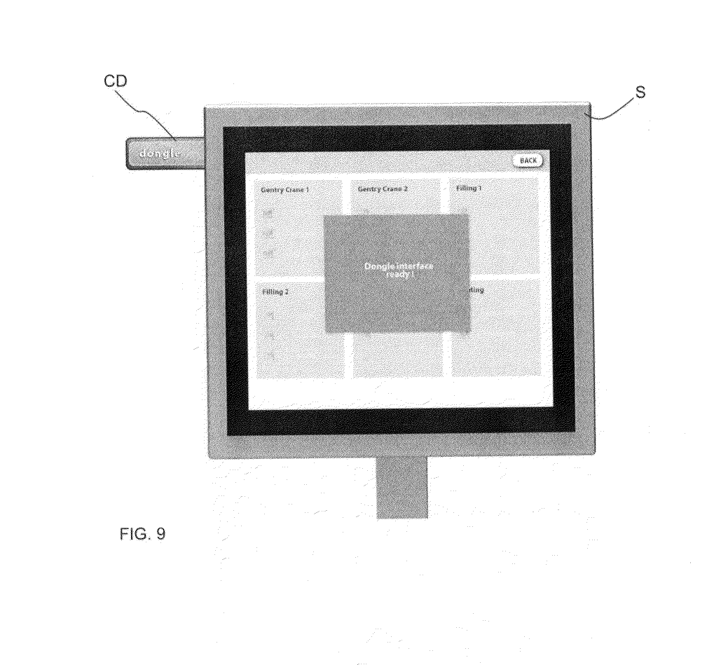

A second alternative is represented in FIG. 9. This time the supervision station S is furnished with means for generating a digital code stored by the software of the supervision station S in the memory of a dongle, USB or other, denoted CD in FIG. 9, able to communicate by Wifi or Bluetooth. The portable terminal T is then fitted with communication means suitable for interacting with the dongle and reading the digital code. Alternatively, the dongle can serve as communication gateway between the portable terminal T and the supervision station S to update the values of the selected parameters 3a, 3b, 3c, 3d.

1-11. (canceled)

12. An onboard supervision system for supervision, from a portable terminal, of a machine connected to a supervision station, the portable terminal including wireless reading means and onboard software, the supervision station including a man-machine interface presenting a set of selectable parameters, the onboard supervision system comprising:
means for selecting by an operator a subset of parameters from among a set of selectable parameters; and
means for generating a code readable by the portable terminal by its wireless reading means, the code including a description of the subset of selected parameters, and wherein the onboard software of the portable terminal generates an onboard man-machine interface displayed on the screen of the portable terminal, the onboard man-machine interface being dependent on the subset of selected parameters.

13. The system as claimed in claim 12, wherein the portable terminal and, respectively, the machine comprise an external communication interface allowing them to communicate with one another.

14. The system as claimed in claim 13, wherein the code further includes a definition of a mode of communication and of a communication protocol and an identifier of the machine.

15. The system as claimed in claim 13, wherein the code is a two-dimensional barcode and the wireless reading means comprises a photographic apparatus and means for decoding the two-dimensional barcode.

16. The system as claimed in claim 13, wherein the code is a digital code stored in a memory of an RFID chip and the wireless reading means comprises an RFID reader.

17. The system as claimed in claim 13, wherein the code is a digital code stored in a memory of a USB dongle configured to communicate by Wifi and the wireless reading means comprises a Wifi communication module.

18. The system as claimed in claim 13, wherein the code is a digital code stored in a memory of a USB dongle configured to communicate by Bluetooth and the wireless reading means comprises a Bluetooth communication module.

19. The system as claimed in claim 13, wherein a value of the parameters of the subset of selected parameters presented on the onboard man-machine interface displayed on the screen of the portable terminal is updated dynamically by the interpretation by means for updating information communicated by the machine to the portable terminal.

20. The system as claimed in claim 13, wherein a mode of communication between the machine and the portable terminal is Wifi.

21. The system as claimed in claim 13, wherein a mode of communication between the machine and the portable terminal is Bluetooth.

22. The system as claimed in claim 13, wherein a mode of communication between the machine and the portable terminal is Zigbee.
